(19) United States
(12) Patent Application Publication
(10) Pub. No.: US 2024/0318001 A1
(43) Pub. Date: Sep. 26, 2024

(54) Thick Film Low Refractive Index Polysiloxane Claddings

(71) Applicant: Optitune Oy, Oulu (FI)

(72) Inventors: Ari Kärkkäinen, Oulu (FI); Rauna-Leena Kuvaja, Oulu (FI); Milja Hannu-Kuure, Oulu (FI); Sacha Legrand, Oulu (FI); Tiina Leppäjärvi, Oulu (FI); Kaisa Malo, Oulu (FI); Isto Kuvaja, Oulu (FI); Merja Myllyaho, Oulu (FI)

(21) Appl. No.: 18/579,374

(22) PCT Filed: Jul. 13, 2022
(86) PCT No.: PCT/FI2022/050496

§ 371 Date: Jan. 15, 2024

(30) Foreign Application Priority Data
Jul. 13, 2021 (FI) 20215803

(51) Int. Cl. C08L 83/06; C09D 5/00; C09D 183/06; G02B 1/11

(52) U.S. Cl. CPC C08L 83/06; C09D 5/006; C09D 183/06; G02B 1/11

(57) ABSTRACT

There is disclosed an optical substrate having a surface and a cladding on said surface, the cladding comprising a polysiloxane polymer, a thickness of at least 1.5 μm, and a refractive index of less than 1.45, measured at 632 nm.

### FIELD

The present invention relates to claddings for optical substrates, optical substrates comprising the claddings, and to optoelectronic devices comprising the optical substrates, wherein the claddings have a high thickness and a low refractive index, as well as to processes for making the same.

### BACKGROUND

There is a need in the art for low refractive index claddings (e.g., films), such as those having a refractive index of 1.50 or less, to provide anti-reflective claddings for various applications. Generally, however, the lower the refractive index, the greater difficulty in obtaining a cladding with a suitable level of thickness, e.g., a thickness of 1500 nm (1.5 micron) or more. Thus, oftentimes, one parameter is traded for another—a lower refractive index cladding is obtained, but with less than a desired thickness, or a cladding with a desired thickness is obtained, but with less than the desired refractive index.

### SUMMARY

Based on the above, it is an aim of the present invention to provide claddings to be applied to a surface of an optical substrate, which have good anti-reflectivity properties, and which have a low refractive index (e.g., 1.45 nm or less) with a thickness (1.5 micron or greater) not yet achieved in the art.

It is also an aim to provide claddings which provide chemically, mechanically, and highly environmentally stable claddings having a refractive index of 1.45 or less and a thickness of at least 1500 nm.

It is another aim of the present invention to produce claddings which are suitable for use in optoelectric devices as antireflective layers, as well as solar modules and cells having carbosilane polymer coatings.

It is another aim of the present invention to improve the efficiency of a photovoltaic module or cell, a luminaire, an organic light emitting diode (OLED), a light emitting diode (LED), and other illumination/light emission sources using the claddings disclosed herein.

These aims and other objects, together with the advantages thereof over known materials and methods, are achieved by the present invention as hereinafter described and claimed.

In one aspect, there is provided an optical substrate having a surface and a cladding on said surface, said cladding comprising a polysiloxane polymer, a thickness of at least 1.5 μm, and a refractive index of less than 1.45, measured at 632 nm.

In another aspect, there is provided a method for forming an optical substrate comprising:
polymerizing a plurality of monomers to form a polysiloxane polymer; and
depositing the polysiloxane polymer on an optical substrate to form a cladding comprising the polysiloxane polymer on the substrate, the cladding having a thickness of at least 1.5 μm and a refractive index of less than 1.45, measured at 632 nm.

In certain embodiments, the monomers have minimal C and H atoms, such as 10% or less, which tend to increase refractive index.

In particular embodiments, the monomers comprise three, four, six or more reactive sites. In this way, the constructed polymers form a three-dimensional (3D) polymer network after polymerization. In certain embodiments, air may be incorporated into the cavities of the 3D polymer network to further reduce the refractive index.

The present inventors have surprisingly found that the disclosed monomers, when polymerized, provide cladding compositions having the unique properties of a film thickness having a refractive index of 1.45 or less and a thickness of at least 1500 nm.

In a particular embodiment, there is provided optical substrate having a surface and a cladding on said surface, said cladding comprising a polysiloxane polymer in the form of a silsesquioxane, a thickness of at least 1.5 μm, and a refractive index of 1.45 or less, measured at 632 nm, wherein the polymer is formed from the polymerization of a plurality of methyltrimethoxysilane (MTMS) monomers along with at least one other monomer according to one or more of the following formulas:

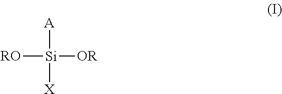

wherein R=alkyl,
A=alkyl, phenyl, vinyl, alkoxy, H atom, 5-(Bicycloheptenyl), glycidoxypropyl, or methacryloxypropyl, and
X=alkyl, phenyl, vinyl, alkoxy, H atom, 5-(Bicycloheptenyl), glycidoxypropyl, or methacryloxypropyl;

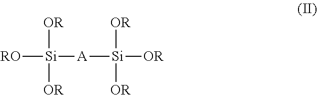

wherein R=alkyl, and
A=alkyl;

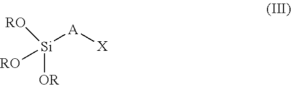

R=alkyl,
A=alkyl, and
X=N,N-bis(2,3-dihydroxypropyl)amino or (3-(allyloxy)-propan-2-ol)amino;

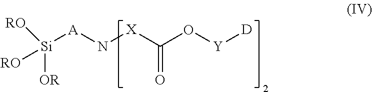

wherein R=alkyl,
A=alkyl,
X=alkyl,
Y=alkyl, and
D=(CF₂)ₙCF₃, wherein n=2 to 20;
or

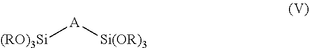

wherein R=alkyl;

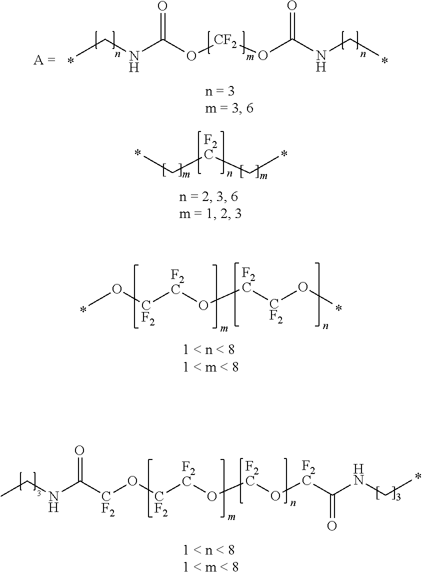

wherein the methyltrimethoxysilane monomers are in molar excess compared to the at least one other monomer according to one or more of formulas (I) to (V).

### EMBODIMENTS

Various exemplifying and non-limiting embodiments of the invention both as to constructions and to methods of operation, together with additional objects and advantages thereof, will be best understood from the following description of specific exemplifying embodiments.

The verbs “to comprise” and “to include” are used in this document as open limitations that neither exclude nor require the existence of also unrecited features. The features recited in depending claims are mutually freely combinable unless otherwise explicitly stated.

As used herein, average molecular weights are provided as weight average molecular weights and may be abbreviated as “Mw.” The molecular weight can be measured, for example, by gel-permeation chromatography using polystyrene standards.

Unless otherwise stated herein or clear from the context, any percentages referred to herein are expressed as percent by weight based on a total weight of the respective composition.

As used herein, the “alkyl” typically stands for linear or branched alkyl group(s) having 1 to 10, preferably 1 to 8, for example, 1 to 6 carbon atoms, such as 1 to 4 carbon atoms, which may be optionally substituted. Such substituents can be selected, for example, from the group of halogen, hydroxyl, vinyl, epoxy and allyl. In a particular embodiment, the alkyl when used herein comprises 1 to 6 carbon atoms.

In accordance with a first aspect of the present invention, there is provided an optical substrate having a surface and a cladding on said surface, said cladding comprising a polysiloxane polymer, a thickness of at least 1.5 μm, and a refractive index of less than 1.45, measured at 632 nm.

In certain embodiments, the thickness may be at least 1.5, 1.6, 1.7, 1.8, 1.9, 2.0, 2.5, 3.0, 3.5, 4.0 μm or more. In certain embodiments, the thickness may be in the range of 1.5 to 2.0 μm, 1.5 to 2.5 μm, 2 to 3 μm, or the like.

The refractive index of the claddings disclosed herein may be measured at a suitable wavelength utilizing any suitable apparatus known in the art, such as on a Woollam spectroscopic ellipsometer. In certain embodiments, the refractive index is measured at 632 nm. In addition, in certain embodiments, the refractive index of the cladding may further be 1.40 or less, 1.35 or less, 1.30 or less, 1.25 or less, or even 1.20 or less, measured at 632 nm. In certain embodiments, the refractive index is in the range of 1.2 to 1.4, such as 1.2 to 1.3 or 1.3 to 1.4, measured at 632 nm.

As used herein, the term “optical substrate” refers to any substrate with or without the cladding thereon described herein, which is designed to exhibit one or more desired optical effects, e.g., reflection, transmission, absorption, or refraction of light upon exposure to a specific band of wavelengths of electromagnetic energy. The substrate may have any suitable thickness and shape. In an embodiment, the substrate may have a planar or a curved shape, and may be relatively rigid or flexible.

The claddings herein may be deposited on any suitable optical substrate to provide the desired optical effect(s), such as in an optical device. In an embodiment, the claddings are deposited on a substrate to provide an antireflective surface. In an embodiment, the optical substrate comprises glass, such as fused silica and fused quartz. In a particular embodiment, the optical substrate comprises a silica glass or an alkali-aluminosilicate glass, such as that used within touch screens for hand-held electronic devices.

In other embodiments, the optical substrate may comprise a polymeric material. Exemplary polymeric materials include, but are not limited to, polycarbonate, polyethylene, polyethylene terephthalate (PET), poly(methyl methacrylate) (PMMA), polystyrene, polyurethane, polyurethane(urea), polyester, polyacrylate, polymethacrylate, poly(cyclic) olefin, polyepoxy, copolymers thereof, and combinations thereof. The polymeric substrates can be formed by any suitable process, such as by casting or moulding, e.g., injection moulding, techniques. In a particular embodiment, the polymeric substrate comprises polycarbonates, poly(cyclic) olefins, polystyrenes, polyurethanes, polymethacrylates, co-polymers of any of the foregoing materials, or mixtures of any of the foregoing. In still other embodiments, the optical substrate may comprise a silicon wafer or indium tin oxide (ITO) glass.

In certain embodiments, the optical substrate comprises a member selected from the group consisting of silica glass, aluminosilicate glass, a silicon wafer, indium tin oxide (ITO) glass, polycarbonate (PC), polyethylene (PE), polyethylene (PE), polyethylene terephthalate (PET), poly(methyl methacrylate) (PMMA), and combinations thereof.

The optical substrate may comprise the thick, low refractive cladding on one surface only or two (opposed) surfaces of the substrate. In certain embodiments, there may be two or more cladding layers on top of each other on either surface or both surfaces (e.g., top and bottom surfaces) of the substrate. In certain embodiments, the claddings described herein are directly applied to a respective surface of the substrate. In still other embodiments, the optical substrate having a cladding may include one or more further layers or substrate materials as an underlayer to the cladding or optical substrate or over the cladding or optical substrate (in a direction away from the substrate). In certain embodiments, there may be an intermediate layer between the substrate and cladding so long as the intermediate layer does not change the optical properties of the cladding.

In certain embodiments, the optical substrate having a cladding thereon as described here may be utilized as a cover substrate or as one of the inner substrates in a device assembly, such as a display device, a touch screen device, a photovoltaic device, luminaires and construction glass units, wherein an antireflective surface is desired.

The claddings described herein may be provided on the optical substrate utilizing any suitable method in the art. In an embodiment, the polysiloxane polymer is deposited on the optical substrate by spin coating. Via spin coating, a small amount of the material to be coated is applied on the center of the substrate and then the substrate is rotated. When the optical substrate is rotated, the spinner spreads the cladding material by centrifugal force. The spun material is also subjected to heating to evaporate off the spin casting solvents, thereby leaving the cladding on the optical substrate. Other suitable application methods include dip coating, spray coating, slit coating, slot coating, and the like. In still other embodiments, the polysiloxane polymer is deposited on the optical substrate to form the cladding by lithography, gravure, embossing, 3D/4D printing, ink-jet printing, laser direct imaging, or the like, or combinations thereof. As set forth below, the deposited polysiloxane polymer may be subjected to thermal treatment and/or vacuum to cure the deposited material to provide a cladding with the desired properties.

In one aspect, the polymer compositions described herein allow for the formation of a cladding on an optical substrate, which may be subsequently laminated with one or additional substrates without the risk of delamination of the cladding. In certain embodiments, the lamination can be applied in front of a display, which is important, for example, for optical touch functionality (e.g., in optical function sensors).

In accordance with an aspect of the present invention, the present inventors have surprisingly found that certain monomers, when polymerized, provide for the novel claddings having the high thickness (1.5 μm or more) and low refractive index (e.g., 1.45 or less measured at 632 nm) described herein. In an embodiment, the polysiloxane polymer of the disclosed claddings is formed via polymerization of a plurality of monomers selected according to one or more of the following formulas (I-VI):

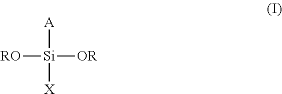

wherein R=alkyl,
A=alkyl, phenyl, vinyl, alkoxy, H atom, 5-(Bicycloheptenyl), glycidoxypropyl, or methacryloxypropyl, and
X=alkyl, phenyl, vinyl, alkoxy, H atom, 5-(Bicycloheptenyl), glycidoxypropyl, or methacryloxypropyl;

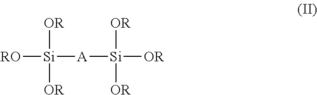

wherein R=alkyl, and
A=alkyl;

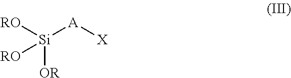

R=alkyl,
A=alkyl, and
X=N,N-bis(2,3-dihydroxypropyl)amino or (3-(allyloxy)-propan-2-ol)amino;

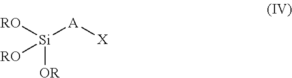

wherein R=alkyl,
A=alkyl, and
X=(CF₂)ₙCF₃, wherein n=3 to 20, such as n=6-8, for example n=7;

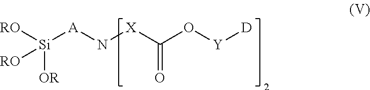

wherein R=alkyl,
A=alkyl,
X=alkyl,
Y=alkyl, and
D=(CF₂)ₙCF₃, wherein n=2 to 20, such as n=2 to 4, for example n=2;
or

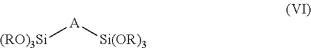

wherein R=alkyl;

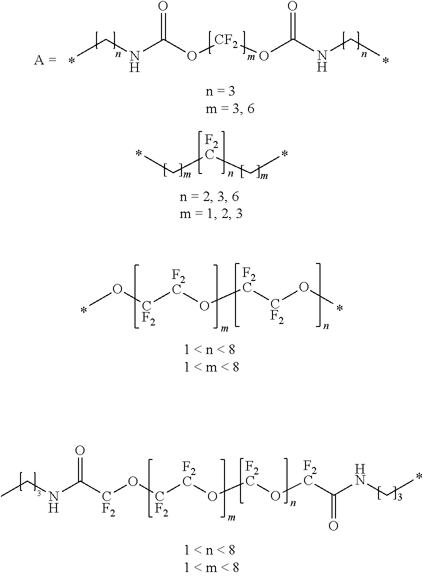

In an embodiment, the polysiloxane polymer is formed at least from monomers according to Formula VI, wherein the monomers of Formula VI are selected from the group consisting of dodecafluorooctyl bis(triethoxysilyl)propyl)carbamate, hexafluoropentyl bis(triethoxysilyl)propyl)carbamate, 4,4,17,17-tetraethoxy-8,8,9,9,10,10,11,11,12,12,13,13-dodecafluoro-3,18-dioxa-4,17-disilaeioxane, 4,4,15,15-Tetraethoxy-7,7,8,8,9,9,10,10,11,11,12,12-dodecafluoro-3,16-dioxa-4,15-disilaeioxane, poly(tetrafluoroethylene), triethoxysilyl terminated, and combinations thereof.

In an embodiment, the polysiloxane polymer of the cladding is formed from polymerization of at least monomers according to Formula (I). In another embodiment, the polysiloxane polymer is formed from polymerization of at least monomers according to Formula (II). In yet another embodiment, the polysiloxane polymer is formed from polymerization of at least monomers according to Formula (III). In yet another embodiment, the polysiloxane polymer is formed from polymerization of at least monomers according to Formula (IV). In yet another embodiment, the polysiloxane polymer is formed from polymerization of at least monomers according to Formula (V). In yet another embodiment, the polysiloxane polymer is formed from polymerization of at least monomers according to Formula (VI).

In certain embodiments, the polysiloxane polymer is formed from the polymerization of two or more monomers selected amongst monomers of Formulas (I), (II), (III), (IV), (V), and (VI).

In certain embodiments, the polysiloxane polymer is formed from the polymerization of both non-fluoro-containing monomers and fluoro-containing monomers. For example, in an embodiment, the polysiloxane polymer may formed from polymerization of monomers selected from one or more of Formulas (I), (II), or (III) along with monomers selected from one or more of Formulas (IV), (V), and (VI).

In certain embodiments, the monomers making up the polysiloxane polymer each comprise 3, 4, or 6 reactive sites to form cavities defined by the polymer backbone. These cavities may further comprise an amount of air therein, which may further decrease the refractive index of the polysiloxane polymer and resulting cladding. In certain embodiments, air is actively introduced into the film compositions comprising the polymer, such as by a continuous or pulsed air flow over and/or into the polysiloxane polymer.

In particular embodiments, the monomers for the polysiloxane polymer described herein are selected from the group consisting of tetraethoxysilane, methyltrimethoxysilane, methyltriethoxysilane, tetramethoxysilane, vinyltrimethoxysilane, 1H,1H,2H,2H-perfluordecyltrimethoxysilane, bis(triethoxysilane)-terminated polyfluoroether, bis(triethoxysilane)-terminated poly(ethylene glycol), silanol-terminated polytrifluoropropylmethylsiloxane, and combinations thereof.

In further embodiments, the monomers for the polysiloxane polymer are selected from the group consisting of methyltrimethoxysilane (MTMS), tetraethoxysilane (TEOS), vinyltrimethoxysilane (VTMS), and combinations thereof.

The formed polysiloxane polymer has a weight average molecular weight of at least 1,000, 2,000, 5,000, 10,000, 20,000, 30,000, 50,000, 100,000 g/mol or more. In an embodiment, the formed polysiloxane polymers has a weight average molecular weight of 1,500 g/mol to 190,000 g/mol; 50,000 to 500,000 g/mol or 100,000 g/mol to 1,000,000 g/mol. Generally, higher weight average molecular weight polymers will provide a lower refractive index amongst polymers formed of the same monomers.

In a particular embodiment, the polysiloxane polymer is in the form of a silsesquioxane. Silsesquioxanes advantageously have both a composition and a cage-like structure to provide a cladding having the refractive index (1.45 or less at 632 nm) and thickness (1.5 micron or greater) properties in accordance with the present invention. In certain embodiments, air may be introduced into the cage-like structure to provide the desired refractive index.

In an embodiment, the present inventors have found that a desirable silsesquioxane polymer may be formed from the polymerization of a plurality of methyltrimethoxysilane (MTMS) monomers along with at least one other (non-MTMS) monomer according to one or more of the following formulas:

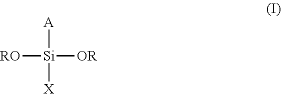

wherein R=alkyl,
A=alkyl, phenyl, vinyl, alkoxy, H atom, 5-(Bicycloheptenyl), glycidoxypropyl, or methacryloxypropyl, and
X=alkyl, phenyl, vinyl, alkoxy, H atom, 5-(Bicycloheptenyl), glycidoxypropyl, or methacryloxypropyl;

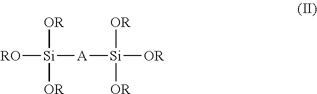

wherein R=alkyl, and
A=alkyl;

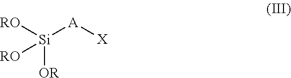

R=alkyl,
A=alkyl, and
X=N,N-bis(2,3-dihydroxypropyl)amino or (3-(allyloxy)-propan-2-ol)amino;

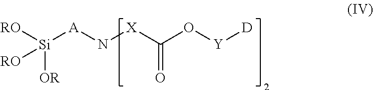

wherein R=alkyl,
A=alkyl,
X=alkyl,
Y=alkyl, and
D=(CF₂)ₙCF₃, wherein n=2 to 20;
or

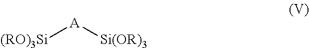

wherein R=alkyl;

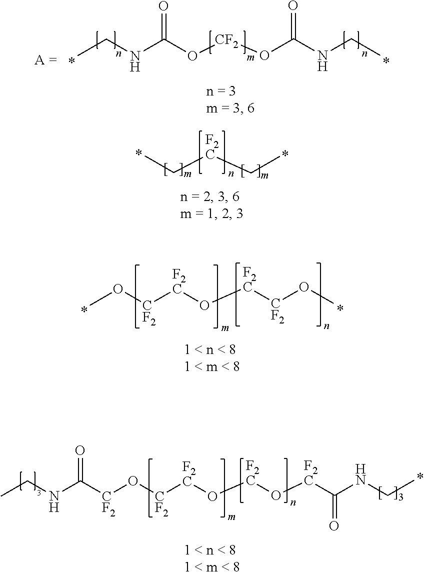

In addition to the cage-like structure of the produced silsesquioxane, MTMS monomers have one of the lowest refractive indices of all silane monomers (see also TEOS and TMS=tetramethoxysilane). Accordingly, it is desirable to have the MTMS monomers provided at least in molar excess to provide the silsesquioxane structure. The other monomers may provide additional functionalities and/or properties to the silsequioxane structure depending on the application. In an embodiment, the MTMS monomers are provided at a molar ratio of at least 5:1 relative to the at least one other monomer according to one or more of formulas (I) to (V), and in certain embodiments 5:1 to 7:1, and in a particular embodiment 7:1. While not wishing to be bound by theory, it is believed that 8 molecules are needed to prepare a silsesquioxane cage-like structure.

In an embodiment, the at least one other monomer comprises an organic functional group for further reaction of the silsesquioxanes. In an embodiment, the at least one other monomer functional group comprises a C═C containing silane, such as vinyl-TMS, vinyl-TEOS, allyl-TEOS, allyl-TMS, or MEMO (3-(Trimethoxysilyl)propyl methacrylate). In certain embodiments, the at least one other monomer comprises vinyl-TMS or vinyl-TEOS, which have a lower refractive index compared to allyl-TEOS, allyl-TMS, or MEMO due to a lesser number of C and O atoms. Such monomers having C═C bonds are suitable for hydrosilylation reaction with Si—H (found in HTEOS) (see Example 10 below). The C═C bond also can be used for radical polymerization to increase the final molecular weight (Example 6) or to react with other C═C containing F-monomers (Examples 7 and 9).

### Synthesis

The synthesis of the polysiloxane polymer for the low refractive index, high thickness cladding may be carried out in at least two steps: hydrolysis and polymerization, preferably by polycondensation. During hydrolysis, a partial condensation is started and a hydrolysis product comprising oligomers of the monomers utilized and unreacted monomers is produced. To accomplish the hydrolysis, in an embodiment, the monomers are hydrolysed in a first solvent and in the presence of a first catalyst.

In certain embodiments, the first solvent may be selected from the group consisting of acetonitrile, acetone, cyclopentanone, methyl isobutyl ketone, propylene glycol methyl ether, propylene glycol methyl ether acetate, propylene glycol n-propyl ether, tetrahydrofuran, toluene, water, and an alcohol, such as methanol, ethanol, 1-propanol, 2-propanol, or the like, and combinations thereof. In a particular embodiment, the first solvent comprises an alcohol, water or a mixture thereof.

In certain embodiments, the first solvent comprises methanol, ethanol, 1-propanol, 2-propanol, propylene glycol methyl ether, or combinations thereof. These solvents may be particularly suitable due to the hydrolysis mechanism of silanes in acidic media. The polymerization of silanes occur via SN1-type reaction, and alcohols were found to be the best solvents for this type of reaction. Legrand et al. J. Appl. Polym. Sci. 2021, volume 138, issue 21, 50467.

The hydrolysis may take place at any suitable temperature, pH, and duration. In an embodiment, the temperature may be from 15° C. to 110° C., from 15 to 60° C., or in certain embodiments from 15-30° C. The pH may be any suitable pH. In certain embodiments, the pH is less than 7, less than 6, or in certain embodiments may be less than 5. In particular embodiments, the pH is from 5 to 7. The reaction time may be any suitable duration, such as from 1 to 24 hours, for example, from 1 to 4 hours.

In an embodiment, the hydrolysis takes place in the presence of a first catalyst. The first catalyst may be any suitable catalyst which facilitates the hydrolysis reaction. In certain embodiments, the first catalyst comprises an acidic catalyst. Exemplary acidic catalysts include, but are not limited to, acetic acid, formic acid, hydrochloric acid, hydrogen fluoride, nitric acid, p-toluenesulfuric acid, sulfuric acid, sulfonic acid, trifluoromethanesulfonic acid, or the like.

In other embodiments, the first catalyst may comprises any suitable basic catalyst which facilitates the hydrolysis reaction. Exemplary basic catalysts include, but are not limited to, ammonium hydroxide, diethylenetriamine, imidazole, tetraethylammonium hydroxide, tetramethylammonium hydroxide, triethylamine, and 1,4-diazabicyclo[2.2.2]octane.

Alternatively, the first catalyst may comprise any other suitable catalyst. For example, the first catalyst may comprise 2,2,3,3,4,4,5,5-octafluoropentylacrylate, poly(ethylene glycol) 200, poly(ethylene glycol) 300, or n-butylated melamine formaldehyde resin. In addition, it is appreciated that the first catalyst may comprise two or more of any of the catalyst materials described herein.

In addition, the first catalyst may be used as such or within a solution, e.g., an aqueous solution, and may be provided in any suitable concentration. In an embodiment, the first catalyst may be provided in solution, e.g., an aqueous solution, at any suitable concentration, such as a concentration of from 0.001M to 3M, and in an embodiment from 0.01 to 2 M. In addition, the molar ratio between the first catalyst and the monomers may comprise any suitable ratio. In an embodiment, the molar ratio between the first catalyst and the monomers may vary from 0.5 to 3, and in particular embodiments from 1 to 2.

In certain embodiments, the hydrolysis step can be performed in presence of a plurality of hollow spheres formed from a suitable polymeric material, such as poly(acrylic acid) (PAA), poly(acrylic acid sodium salt) (PASS), polydiallyldimethylammonium chloride (poly(DADMAC)), or the like. The hollow sphere serves as a template for the preparation of the polymer and may be removed downstream, such as by washing.

In certain embodiments, the polymerization process comprises one or more washing steps to reduce or eliminate the presence of low molecular weight components, e.g., dimers, trimers, or tetramers, or otherwise component having a weight average molecular weight of 2000 or less. In an embodiment, one or more washing steps are performed after the hydrolysis step using one or more wash solvents. In an embodiment, when water is not used as the first solvent, the wash solvent may comprise water, such as deionized water. In other embodiments, the wash solvent may comprise an aqueous solution comprising a suitable salt therein, such as sodium chloride, Rochelle salt (sodium potassium L(+)-tartrate tetrahydrate), or ammonium chloride.

In certain embodiments, the polymerization process further comprises a solvent exchange step, wherein the first solvent is exchanged for one or more additional solvents which will extract any of the oligomers formed during hydrolysis and remaining monomers to provide the hydrolysis product for the downstream polycondensation reaction. In addition, the solvent exchange may assist in the removal of water and alcohols formed during hydrolysis of the silane monomers. The additional solvent may comprise the same solvent as the first solvent or a different solvent.

Exemplary solvents for use as the additional solvent in the solvent exchange include, but are not limited to, propylene glycol methyl ether, propylene glycol methyl ether acetate, 1-ethanol, 2-ethanol, acetonitrile, propylene glycol n-propyl ether, methyl tert-butyl ether, (MTBE) or combinations thereof. The additional solvent may be used as such or in solution, e.g., an aqueous solution, such as an MTBE-water solution. The solvent exchange step may be repeated, if necessary, to prepare the hydrolysis product for polycondensation.

Once the hydrolysis product is provided, optionally after washing and solvent exchange, the hydrolysis product is then subjected to a polymerization step to yield the polysiloxane polymer for low refractive index, high thickness cladding. In the polymerization step, the molecular weight of the hydrolysis product is further increased by condensation polymerization to provide the polysiloxane polymer.

The polycondensation step may be performed in the presence of a second catalyst. The second catalyst may be different from the first catalyst or may be the same catalyst as the first catalyst. In the latter case, the second catalyst is preferably fresh new catalyst. In any case, the second catalyst may be any suitable catalyst for promoting the polymerization process. In certain embodiments, the second catalyst may be selected from a Pt-containing catalyst, such as the Speier catalyst (H₂PtCl₆·H₂O) or Karstedt's catalyst (Pt(0)-1,3-divinyl-1,1,3,3-tetramethyldisiloxane complex solution), or a Rh-based catalyst, such as Tris(triphenylphosphine)rhodium (I) chloride.

Similar to hydrolysis, the polycondensation reaction may take place at any suitable temperature, pH, and duration. The temperature may be from 20° C. to 105° C., from 60° C. to 95° C., or in certain embodiments from 70° C. to 95° C. The pH may be any suitable pH. In certain embodiments, the pH is greater than 7, greater than 10, or greater than 12. In certain embodiments, the pH is from 10 to 12. The reaction time may be any suitable duration, such as from 15 minutes to 12 hours, and in a particular embodiment from 45 minutes to 4 hours.

In certain embodiments, resulting free Si—OH groups present in the polymer backbone of the formed polysiloxane polymer can be protected with a suitable endcapping agent. Without limitation, the endcapping agent may be selected from the group consisting of fluoro(difluoromethylene)methyl silane, dimethoxy fluoro methyl silane, (2-chloroethyl)trimethoxysilane, ethyltrimethylsilane, ethyltriethylsilane, ethyltriethoxysilane, ethyltrimethoxysilane, chlorotrimethylsilane, chlorotriethylsilane, n-butyldimethylchlorosilane, t-butyldimethylchlorosilane, t-butyldiphethylchlorosilane, 4-(t-butyl)phenethyldimethylchlorosilane, chlorodimethylisobutylsilane, chlorodimethyl-n-propylsilane, (chloromethyl)dimethylphenylsilane, (chloromethyl)trimethylsilane, (3-chloropropyl)trimethylsilane, chlorotri-n-butylsilane, chlorotri-n-propylsilane, (3,3-dimethylbutyl)dimethylchlorosilane, ethyldimethylchlorosilane, isobutyldimethylchlorosilane, isopropyldimethylchlorosilane, t-hexyldimethylchlorosilane, p-tolyldemethylchlorosilane, triethylchlorosilane, and combinations thereof. Alternatively, any other suitable endcapping agent may be utilized.

In certain embodiments, the polymerization takes place in the presence of a radical initiator, such as AIBN: 2,2′-Azobis(2-methylproponitrile), ABCV: 4,4′-Azobis(4-cyanovaleric acid), ABCC: 1,1′-Azobis(cyclohexanecarbonitrile) or ABMP: 4,4′-Azobis(2-methylpropane).

In certain embodiments, the polymerization is done by the following steps utilizing the materials described above:
mixing monomers according to one or more of Formulas (I) to (VI) with a first solvent and a first catalyst under conditions effective to hydrolyze the monomers and form a first reaction mixture; and
performing a first solvent extraction of the first reaction mixture with a first aqueous solvent to provide a first organic phase comprising the monomers, wherein the first aqueous solvent is different from the first solvent;
changing the first solvent to a second solvent to form a second reaction mixture;
subjecting the second reaction mixture to a polycondensation reaction for polymerizing and cross-linking of the monomers in the second reaction mixture; and
performing a second solvent extraction of the second reaction mixture with a second aqueous solvent to provide a second phase comprising the polymer formed from the monomers according to one or more of formulas (I) to (VI).

Following the polymerization, e.g., polycondensation reaction, a cladding comprising the formed polymer may be produced by depositing the polysiloxane polymer on an optical substrate as described herein. In certain embodiments, the polysiloxane material is cured to a final hardness and thickness, prior to, during, or following deposition on the optical substrate. The curing may be done by subjecting the polysiloxane to ultraviolet (UV) light for a suitable duration, e.g., from 1 to 24 hours, followed by thermal treatment. The thermal treatment may be done by heating the polysiloxane polymer to a temperature of at least 50° C., at least 75° C., or at least 100° C., such as from 50° C. to 150° C., for a suitable duration, such as 30 minutes to 24 hours, for example, 1 to 4 hours. In certain embodiments, the polysiloxane polymer is subjected to a pre-curing step, wherein solvent is evaporated and the polysiloxane polymer by vacuum, thermal treatment, or the like.

The resulting cladding on the optical substrate surface has the refractive index of 1.45 or less, 1.40 or less, 1.35 or less, 1.30 or less, 1.25 or less, or even 1.20 or less, measured at 632. In certain embodiments, the refractive index is in the range of 1.25 to 1.4, such as 1.3 to 1.4, measured at 632 nm. In addition, the formed cladding has the thickness of at least 1.5, 1.6, 1.7, 1.8, 1.9, 2.0, 2.5, 3.0, 3.5, 4.0 μm or more, such as from 1.5 to 2.0 μm or 1.5 to 2.5 μm.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

The verbs “to comprise” and “to include” are used in this document as open limitations that neither exclude nor require the existence of also unrecited features. The features recited in depending claims are mutually freely combinable unless otherwise explicitly stated. Furthermore, it is to be understood that the use of “a” or “an,” that is, a singular form, throughout this document does not exclude a plurality.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

### EXAMPLES

Examples 1-3 aimed to prepare polysiloxanes with a maximum amount of silicon atoms with a minimal amount of carbon atoms. The synthesis of such polymers was as follows:

Example 1: In a 500 mL round bottom flask, EtOH (81.5 g) and HCl (3M aqueous solution; 16.97 g) are mixed. A mixture TEOS (15 g)-MTMS (5.28 g) is added and the reaction mixture is stirred at room temperature for 3.5 h. Then, the reaction mixture is transferred to a separation funnel. Methyl tertiary-butyl ether (MTBE) (124.68 g) is added, together with DI-water (111.62 g). The reaction mixture is shaken and additional DI-water (54 g) is added. After separation of the phases, the organic phase is washed with additional DI-water (3×54 g). After separation of the phases, EtOH (110 g) is added to the organic phase. Solvent exchange procedure from EtOH to EtOH is performed. After stirring overnight at room temperature, the solid content of the reaction mixture is adjusted to 4% by addition of ethanol. TEA (2% of the solid material; 0.077 g), dissolved in EtOH (2 mL) is added. The reaction mixture is stirred at T=95° C. for 20 min and then is transferred to a separation funnel. DI-water (42.64 g) and MTBE (85.3 g) are added. The organic phase is washed with additional DI-water (7×42.64 g). After separation of the phases, EtOH (56 g) is added to the organic phase and solvent exchange procedure from ethanol to ethanol is performed. CITMS (1% of solid material, 0.03 g) in EtOH (0.56 g) is added and the mixture is stirred at T=105° C. for 30 min. After cooling to room temperature, some EtOH is removed under low pressure to get a solution with solid content of 4% before processing.

Example 2: In a 500 mL round bottom flask, EtOH (81 g) and HCl (1M aqueous solution; 16.97 g) are mixed. A mixture TEOS (15 g)-MTMS (3.77 g)-Dimethyldiethoxysilane (DMDEOS) (1.63 g) is added at room temperature. The reaction mixture is then stirred at room temperature for 3.5 h. Then, the reaction mixture is transferred to a separation funnel. MTBE (124.68 g) is added, together with DI-water (111.62 g). The reaction mixture is shaken and additional DI-water (54 g) is added. After separation of the phases, the organic phase is washed with additional DI-water (2×54 g). After separation of the phases, IPA (110 g) is added to the organic phase. Solvent exchange procedure from EtOH to IPA is performed. After stirring overnight at room temperature, the solid content of the reaction mixture is adjusted to 4% by addition of IPA. TEA (1.75% of the solid material; 0.073 g), dissolved in IPA (2 mL) is added. The reaction mixture is stirred at T=95° C. for 45 min and then is transferred to a separation funnel. DI-water (42.64 g) and MTBE (85.3 g) are added. The organic phase is washed with additional DI-water (4×42.64 g). After separation of the phases, IPA (50 g) is added to the organic phase and solvent exchange procedure from IPA to IPA is performed.

Example 3: In a 500 mL round bottom flask, propylene glycol methyl ether (PGME) (81 g) and HCl (0.1M aqueous solution; 16.48 g) are mixed. A mixture TEOS (15 g)-MTMS (3.77 g)-DMDEOS (1.63 g) is added and the reaction mixture is stirred at room temperature for 3.5 h. Then, the reaction mixture is transferred to a separation funnel. MTBE (124.68 g) is added, together with DI-water (111.62 g). The reaction mixture is shaken. After separation of the phases, the organic phase is washed with additional DI-water (1×70 g and 1×25 g). After separation of the phases, PGME (110 g) is added to the organic phase. Solvent exchange procedure from PGME to PGME is performed. After stirring overnight at room temperature, the solid content of the reaction mixture is adjusted to 4% by addition of PGME. TEA (2% of the solid material; 0.065 g), dissolved in PGME (2 mL) is added. The reaction mixture is stirred at T=105° C. for 45 min and then is transferred to a separation funnel. DI-water (25 g) and MTBE (40 g) are added. The organic phase is washed with additional DI-water (4×30 g). After separation of the phases, propylene glycol methyl ether acetate (PGMEA) (50 g) is added to the organic phase and solvent exchange procedure from PGME to PGMEA is performed. The final solid content was 5.28% and the reaction mixture was processed as such.

### Silsesquioxanes:

Examples 4-5 aimed prepare silsequioxanes (cage-like polysiloxanes) which would allow for the further introduction of air (RI=0) into the polymer. The synthesis of such polymers was as follows:

Example 4: In a 1 L round bottom flask, MTMS (100 g) is dissolved in MeOH (100 g). HCOOH (118.8 g; 0.1 M; aqueous solution) is added dropwise and the reaction mixture is refluxed at T=95° C. for 2 h. The reaction mixture is then cooled to room temperature. PGME (100 g) is added and solvent exchange from MeOH to PGME is performed. The solid content of the final solution is adjusted to 25% by adding additional amount of PGME. A representative example of silsesquioxane prepared from the monomer MTMS is as follows:

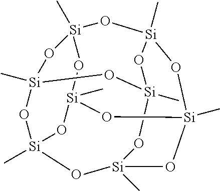

Example 5: In a 1 L round bottom flask, MTMS (100 g) and TEOS (21.72 g) are dissolved in MeOH (121.72 g). HCOOH (139.86 g; 0.1 M, aqueous solution) is added dropwise and the reaction mixture is refluxed for 2 h. After cooling to room temperature, PGME (120 g) is added and solvent exchange from MeOH to PGME is performed. The solid content of the solution is adjusted to 50% by addition of PGME. A representative example of silsesquioxane prepared from the monomer MTMS and TEOS is shown below.

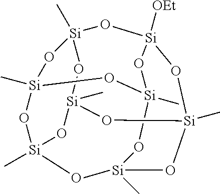

Structure of a silsesquioxane prepared from the monomer methyltrimethoxysilane (MTMS) and tetraethoxysilane (TEOS) with a molar ratio of MTMS/TEOS=7/1

The aim of Examples 6-7 were similar to Examples 4-5, but a reactive site (vinyl group) was also introduced on the edge of the cage for additional chemical modification, namely increasing the molecular weight by radical polymerization of C═C (Example 6) or to introduce F-containing chemical entities (Example 7). Higher Mw and F atoms were likely helpful to decrease the final refractive index (RI) of the material.

The formed polymer was subjected to spin-coating on silicon wafer at 400-2000 rpm. Thereafter, the coated silicon wafer was baked at T=200° C. for 5 min. The refractive index and thickness were measured using filmetric apparatus and/or ellipsometer at 632.9 nm. Several coatings (up to 5 layers) were attempted in some instance in an attempt to reach the target of 1500 nm. In this Example (5), a cladding with a refractive index of 1.37, measured at 632 nm, and a thickness of 1.690 nm was provided.

Example 6: In a 1 L round bottom flask, MTMS (100 g) and VTMS (15.46 g) are dissolved in MeOH (115.46 g). HCOOH (135.14 g; 0,1M, aqueous solution) is added dropwise and the reaction mixture is refluxed for 2 h. After cooling to room temperature, PGME (120 g) is added and solvent exchange from MeOH to PGME is performed. The solid content of the solution is adjusted to 50% by addition of PGME. A part of the previous solution (64.9 g; 50% in PGME) is transferred to a new 1 L round bottom flask. AIBN (1% of solid material; 0.32 g) is added and the reaction mixture is stirred at T=105° C. for 2.5 h (scheme 1).

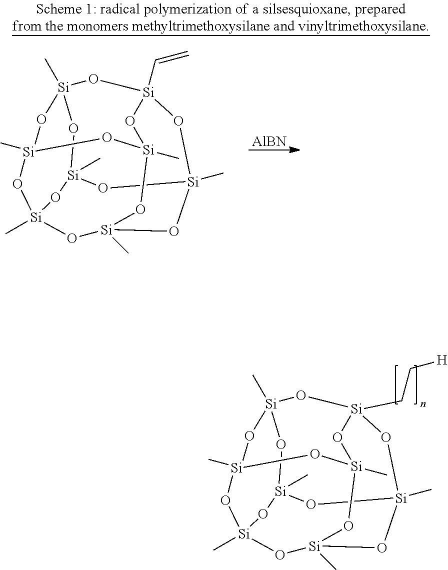

The formed polymer was subjected to spin-coating on silicon wafer at 400-2000 rpm. Thereafter, the coated silicon wafer was baked at T=200° C. for 5 min. The refractive index and thickness were measured using filmetric apparatus and/or ellipsometer at 632.9 nm. Several coatings (up to 5 layers) were attempted in some instance in an attempt to reach the target of 1500 nm. In this Example (6), a cladding with a refractive index of 1.34, measured at 632 nm, and a thickness of 2.221 nm was provided.

Example 7: In a 1 L round bottom flask, MTMS (100 g) and VTMS (15.46 g) are dissolved in MeOH (115.46 g). HCOOH (135.14 g; 0,1M, aqueous solution) is added dropwise and the reaction mixture is refluxed for 2 h. After cooling to room temperature, PGME (120 g) is added and solvent exchange from MeOH to PGME is performed. The solid content of the solution is adjusted to 50% by addition of PGME. A part of the previous solution (16 g; 50% in PGME) is transferred to a new 100 mL round bottom flask. PGME (16 g) is added together with the acrylate OFPA (0.16 g) and AIBN (0.08 g). The resulting reaction mixture is refluxed for 1 h.

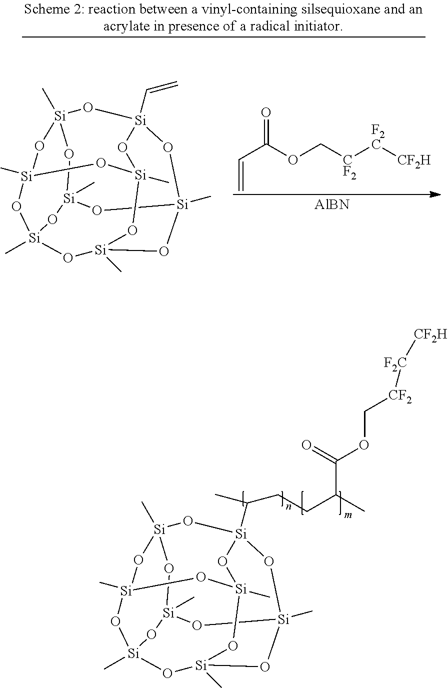

In Example 8, (2,3-dihydroxypropyl)-3-amino groups were introduced in order to build “tunnel-like” silsesquioxane structures to introduce more air in the system.

Example 8: In a 250 mL round bottom flask, Bis(2,3-dihydroxypropyl)-3-aminopropyltrimethoxysilane (4) (15 g) was dissolved in DI-H₂O (32 g). HCOOH (40 g; 0.1M, aqueous solution) was added dropwise and the reaction mixture was refluxed for 2 h. Then, the reaction mixture was cooled to room temperature and was transferred to a new 250 mL round bottom flask. H₂O (40 g) was added and solvent exchange from H₂O to H₂O was performed. The solution was adjusted to 50%.

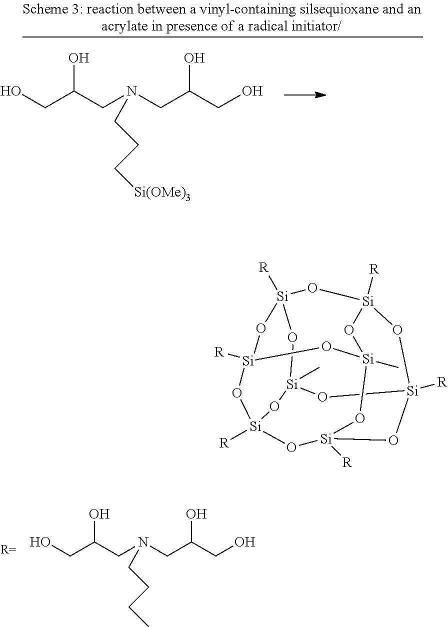

In Example 9, CF₃(CF₂)₇ groups on the surface of the cage in an attempt to decrease RI via F atoms.

Example 9: In a 1 L round bottom flask, MTMS (100 g) and F17 (CF₃(CF₂)₇(CH₂)₂Si(OMe)₃; 59 g) were mixed together in MeOH (160 g). HCOOH (0.1 M; 135.14 g) was added dropwise and the reaction mixture was then refluxed for 2 h. The reaction mixture was then cooled to room temperature and was transferred to a new 1 L round bottom flask. PGME (150 g) was added and solvent exchange procedure from MeOH to PGME was performed. The solid content was adjusted to 50% by addition of PGME (21.1 g). A silsesquioxane prepared from the monomer MTMS and F17 with a molar ratio of MTMS/F17=7/1 is as follows:

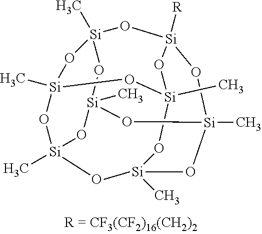

In Example 10, a Si—H reactive group was introduced on the surface on the cage. The Si—H group reacted with the C=C group (Example 6) via hydrosilylation to create two series of tunnels and to allow more air introduction into polymer network.

Example 10: Solution A: in a 1 L round bottom flask, MTMS (100 g) and hexadecyltrimethoxysilane (HTEOS) (17.11 g) are dissolved in MeOH (117 g). HCOOH (135.14 g; 0,1M, aqueous solution) is added dropwise and the reaction mixture is refluxed for 2 h. After cooling to room temperature, PGME (150 g) is added and solvent exchange from MeOH to PGME is performed. The solid content of the solution is adjusted to 50% by addition of PGME.

Solution B: in a 1 L round bottom flask, MTMS (100 g) and VTMS (15.46 g) are dissolved in MeOH (115.46 g). HCOOH (135.14 g; 0.1M, aqueous solution) is added dropwise and the reaction mixture is refluxed for 2 h. After cooling to room temperature, PGME (120 g) is added and solvent exchange from MeOH to PGME is performed. The solid content of the solution is adjusted to 50% by addition of PGME.

Final solution: in a 250 mL 3 necks round bottom flask, part of the solution A (10 g; 50% solid content in PGME) and part of the solution B (10 g; 50% solid content in PGME) are mixed in PGME (80 g). The catalyst (H₂PtCl₆·H₂O; 0.5 mL: 10% in IPA) is added and then the reaction mixture is stirred at T=70° C. for 4 h and then at room temperature overnight (scheme 2).

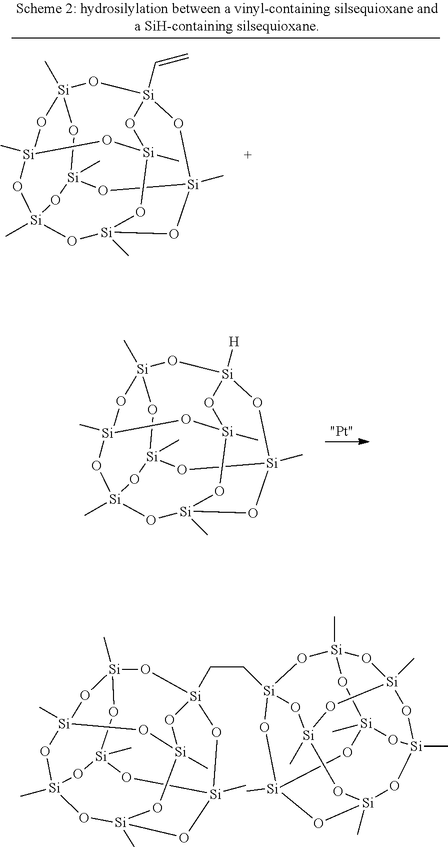

In Example 11, (2,3-dihydroxypropyl)-3-amino groups were introduced in order to build “tunnel-like” silsesquioxane structures to introduce more air in the system.

Example 11: Preparation of N,N-di(2,3-dihydroxypropyl)(aminopropyl)triethoxysilane (4) (scheme 3): glycidol (33.06 g) is poured into a 250 mL 3 necks round bottom flask. The reaction mixture is cooled with the help of ice-bath. (3-Aminopropyl)trimethoxysilane (APTMES) (40 g) is added slowly at T=0° C. When the addition is completed, the reaction mixture is allowed to reach room temperature and is followed by TLC (eluent: cyclohexane/ethyl acetate: 1/3). The starting material disappears after 1 h. The resulting reaction mixture is used in the next step without purification process.

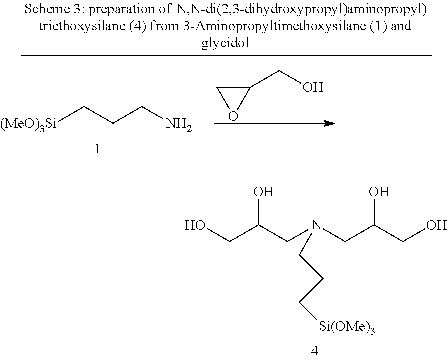

In a 3 necks 500 mL round bottom flask, N,N-di(2,3-dihydroxypropyl) (aminopropyl) triethoxysilane (40 g) is dissolved in MeOH (180 g). HF (6.84 g; 3.2%; aqueous solution) is added dropwise and the reaction mixture is stirred at room temperature for 2 h. The reaction mixture is transferred to a new 1 L round bottom flask and IPA (110 g) is added. Solvent exchange procedure from MeOH to IPA is performed. The resulting reaction mixture is ready for processing.

In Example 12, 3-(allyloxy)propan-2-ol groups were introduced in order to build “tunnel-like” silsesquioxane structures to introduce more air in the system.

Example 12: Preparation of 1-(3-(trimethoxysilyl)propylamino)-3-(allyloxy)propan-2-ol (3) (scheme 4): in a 100 mL 3 necks round bottom flask, APTMES (10 g) was cooled to T=0° C. Allyl glycidyl ether (33.51 g) is added dropwise at T=0° C.

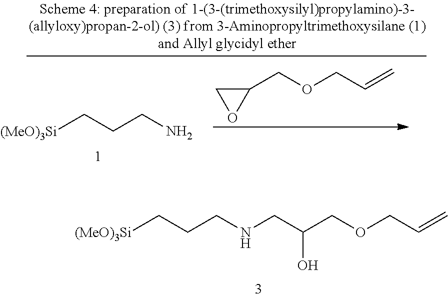

In a 250 mL 3 necks round bottom flask, 1-(3-(trimethoxysilyl)propylamino)-3-(allyloxy)propan-2-ol (30 g) is dissolved in acetone (92 g). HF (3.15 g; 3.2%; aqueous solution) is added dropwise. Then, the reaction mixture is stirred at T=30° C. for 6 h and at room temperature overnight. The reaction mixture is then transferred to a 500 mL round bottom flask and ethanol (100 g) is added. Solvent exchange procedure from acetone to ethanol is performed. The solid content of the material was adjusted to 50% by addition of ethanol (11 g). The resulting reaction mixture is ready for processing.

In Example 13, a combination of the techniques described for Example 8, 11 and 12, and example 9 were used in an attempt to form a polymer network (e.g., tunnel structure) with F-containing molecules.

Example 13: Preparation of Bis[(2,2,3,3,4,4-hexafluorobutyl)propanoic ester]-3-aminopropyltrimethoxysilane (5) (scheme 5): in a 100 mL 3 necks round bottom flask, APTMES (10 g) was cooled to T=0° C. OFPA (33.51 g) is added dropwise at T=0° C. The reaction mixture was allowed to reach room temperature and then was stirred at T=60° C. for 18 h. The reaction was monitored by TLC (eluent: cyclohexane/EtOAc=3/1). Excess of OFPA was removed under low pressure.

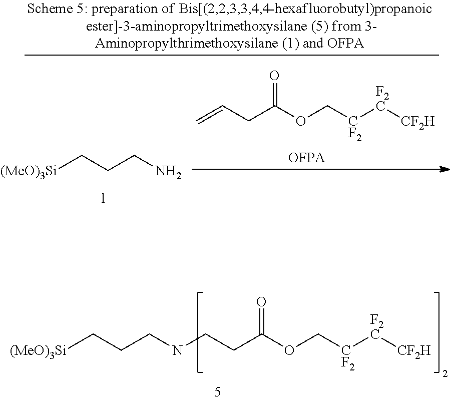

The monomer 5 (30 g) was dissolved in acetone (92 g). HF (3.2%; 3.15 g) was added dropwise and the reaction mixture was stirring at T=30° C. for 6 h. The reaction mixture was transferred to a new 1 L round bottom flask. EtOH (100 g) was added and solvent exchange procedure from acetone to EtOH was performed. The solid content was adjusted to 50% by addition of EtOH (11 g).

In Example 14, Si-atoms were used to minimise the final RI and a poly(fluorinated ether) (shown below) was introduced at the end of the process to further decrease the RI.

Example 14: In a 50 mL round bottom flask, TEOS (2.5 g) and DI-water (0.83 g) are mixed. HCl (0.28 g; 0.1 M; aqueous solution) is added dropwise. The reaction mixture is then stirred at room temperature for 1 h. Then, the below poly(fluorinated ether) (4.1 g) is added and the reaction mixture is stirred for few minutes. EtOH (10 g) is then added and the reaction mixture is processed immediately. The poly(fluorinated ether) included a mixture of different monomers with various weight average molecular weights (Mw), e.g., 1750<Mw<1950.

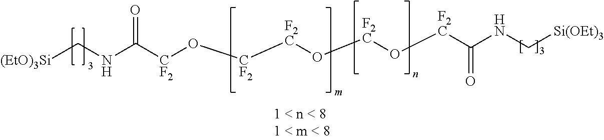

The formed polymer was subjected to spin-coating on silicon wafer at 400-2000 rpm. Thereafter, the coated silicon wafer was baked at T=200° C. for 5 min. The refractive index and thickness were measured using filmetric apparatus and/or ellipsometer at 632.9 nm. Several coatings (up to 5 layers) were attempted in some instance in an attempt to reach the target of 1500 nm. In this Example (14), a cladding with a refractive index of 1.30, measured at 632 nm, and a thickness of 2.893 nm was provided.

In Examples 15-17, poly(acrylic acid (PAA) was used as a template and the polysiloxane was built around the template. After removing of the template by extraction, a cavity should have been present in the system ‘to enable air to penetrate the polymeric structure and decrease the final RI.

Example 15: In a 500 mL round bottom flask, a mixture poly(acrylic acid) (0.9 g; M_{w}=5 000)-diethylenetriamine (13 mL; 30% w/w in water) is added to EtOH (300 mL). After few minutes of stirring, TEOS (1.5 mL) is added and the reaction mixture is stirred at room temperature overnight. The reaction mixture is then transferred to a separation funnel. DI-water (60 mL) is added. After shaking, MTBE (60 g) is added. The process is repeated two times. A saturated solution of aqueous solution of potassium sodium tartrate salt (60 g) is added to break the emulsion formed between water and the organic phase. After separation of the phases, PGME is added to the organic phase. Then solvent exchange procedure from EtOH and PGME is performed.

Example 16: In a 1 L round bottom flask, MTMS (100 g) and poly(acrylic acid) (10 g; M_{w}=5 000) were mixed. EtOH (100 g) was added. HCOOH (0.1 M; 118.8 g) was added dropwise and the reaction mixture was refluxed for 2 h. After cooling to room temperature, the reaction mixture was transferred to a new 1 L round bottom flask and PGMEA (100 g) was added. Solvent exchange procedure from EtOH to PGMEA was performed. CH₃CN (100 mL) and DI-H₂O (100 mL) were added. After separation of the phases, the solid content of the organic phase was measured and adjusted to 20% by addition of PGMEA.

Example 17: In a 100 mL round bottom flask, MTMS (16 g) and poly(acrylic acid) (10 g; M_{w}=5 000) were mixed. EtOH (16 g) was added. HCOOH (0.1 M; 19 g) was added dropwise and the reaction mixture was refluxed for 2 h. After cooling to room temperature, the reaction mixture was transferred to a 250 mL round bottom flask and PGMEA (16 g) was added. Solvent exchange procedure from EtOH to PGMEA was performed. PGMEA (10 g) and DI-H₂O (20 mL) were added. The organic phase was washed with DI-water (2×20 g and 1×100 g). After separation of the phases, the solid content of the organic phase was measured and adjusted to 10% by addition of PGMEA.

In Examples 18-24, a series of three-dimensional polysiloxanes were formed to attempt to increase the thickness of the films.

Example 18: In a 1 L round bottom flask, methyltriethoxysilane (90 g), phenyltrimethoxysilane (9.41 g), 3-(trimethoxysilyl)propylmethacrylate (6.53 g), (3-Glycidoxypropyl)trimethoxysilane (67.36 g), 1,2-Bis(triethoxysilyl)ethane (37.42 g) and Bis(trimethoxysilyl)ethane (14.26 g) are mixed in PGME (62.32 g). HNO₃ (0.1 M; aqueous solution; 62.32 g) is added dropwise and the reaction mixture is stirred at T=105° C. for 2 h. The reaction mixture is then cooled to room temperature and is transferred to a 2 L round bottom flask. PGME (150 g) is added and solvent exchange procedure from PGME to PGME is performed. The solid content is adjusted to 50% by addition of PGME (40 g). AIBN (1.4% of material; 2.01 g) is added and the reaction mixture is stirred at T=105° C. for 1 h.

Example 19: In a 1 L round bottom flask, dimethyldiethoxysilane (71.03 g), phenylmethyldimethoxysilane (21.87 g), methacryloxypropylmethyldimethoxysilane (5.80 g), (3-Glycidoxypropyl)methyldimethoxysilane (59.49 g), 1,2-Bis(triethoxysilyl)ethane (35.46 g) are mixed in acetone (193.65 g). HNO₃ (0.1 M; aqueous solution; 59.07 g) is added dropwise and the reaction mixture is stirred at T=105° C. for 2 h. The reaction mixture is then cooled to room temperature and is transferred to a 1 L round bottom flask. PGME (100 g) is added and solvent exchange procedure from PGME to PGME is performed. AIBN (3% of material; 2.7 g) is added and the reaction mixture is stirred at T=105° C. for 3 h 30.

Example 20: In a 1 L round bottom flask, dimethyldiethoxysilane (71.03 g), diphenyldimethoxysilane (30.30 g), Glycidoxypropyl)trimethoxysilane (63.81 g), 5-(Bicycloheptenyl)triethoxysilane (6.41 g), 1,2-Bis(triethoxysilyl)ethane (35.46 g) are mixed in acetone (207 g). HNO₃ (0.1 M; aqueous solution; 58.5 g) is added dropwise and the reaction mixture is stirred at T=105° C. for 2 h. The reaction mixture is then cooled to room temperature and is transferred to a 1 L round bottom flask. PGME (100 g) is added and solvent exchange procedure from acetone to PGME is performed. The solid content is adjusted to 50% by addition of PGME (12 g). AIBN (3% of material; 1.56 g) is added and the reaction mixture is stirred at T=105° C. for 3 h.

Example 21: In a 1 L round bottom flask, dimethyldiethoxysilane (85.85 g), Glycidoxypropyl)trimethoxysilane (58.22 g), 5-(Bicycloheptenyl)triethoxysilane (5.71 g), 1,2-Bis(triethoxysilyl)ethane (31.55 g) are mixed in acetone (180 g). HNO₃ (0.1 M; aqueous solution; 52.11 g) is added dropwise and the reaction mixture is stirred at T=105° C. for 2 h. The reaction mixture is then cooled to room temperature and is transferred to a 1 L round bottom flask. PGME (100 g) is added and solvent exchange procedure from acetone to PGME is performed. The solid content is adjusted to 50% by addition of PGME (12 g). AIBN (3% of material; 1.56 g) is added and the reaction mixture is stirred at T=105° C. for 3 h.

Example 22: In a 1 L round bottom flask, dimethyldiethoxysilane (71.03 g), phenylmethyldimethoxysilane (22.78 g), methacryloxypropyltrimethoxysilane (6.20 g), (3-glycidoxypropyl)methyldimethoxysilane (59.49 g), Bis(triethoxysilyl)ethane (35.46 g) are mixed together in acetone (194.96 g). HNO₃ (0.1 M; aqueous solution; 58.5 g) is added dropwise and the reaction mixture is stirred at T=105° C. for 2 h. The reaction mixture is then cooled to room temperature and is transferred to a 1 L round bottom flask. PGME (100 g) is added and solvent exchange procedure from acetone to PGME is performed. The solid content is adjusted to 50% by addition of PGME (27 g). AIBN (3% of material; 2.71 g) is added and the reaction mixture is stirred at T=105° C. for 3 h.

Example 23: In a 1 L round bottom flask, dimethyldiethoxysilane (74.88 g), methacryloxypropyltrimethoxysilane (6.20 g), (3-glycidoxypropyl)trimethoxysilane (63.81 g), Bis(triethoxysilyl)ethane (27.04 g) are mixed in acetone (172 g). HNO₃ (0.1 M; aqueous solution; 58.5 g) is added dropwise and the reaction mixture is stirred at T=105° C. for 2 h. PGME (100 g) is added and solvent exchange procedure from acetone to PGME is performed. The solid content is adjusted to 50% by addition of PGME (12 g). AIBN (3% of material; 2.71 g) is added and the reaction mixture is stirred at T=105° C. for 3 h.

Example 24: In a 1 L round bottom flask, dimethyldiethoxysilane (89.71 g), methacryloxypropyltrimethoxysilane (6.20 g), (3-glycidoxypropyl)trimethoxysilane (63.81 g), Bis(triethoxysilyl)ethane (27.04 g) are mixed in acetone (187 g). HNO₃ (0.1 M; aqueous solution; 58.5 g) is added dropwise and the reaction mixture is stirred at T=105° C. for 2 h. PGME (100 g) is added and solvent exchange procedure from acetone to PGME is performed. The solid content is adjusted to 50% by addition of PGME (7.9 g). AIBN (3% of material; 2.71 g) is added and the reaction mixture is stirred at T=105° C. for 2 h.

In Example 25, a linear homopolysiloxane was formed using dimethoxymethyvinylsilane as a precursor.

Example 25: In a 3 necks 250 mL round bottom flask, Dimethoxymethylvinylsilane (25 g) was dissolved in acetone (25 g). HNO₃ (0.1 M; 13.61 g) was added dropwise and the reaction mixture was refluxed for 2 h. Then, the reaction mixture was cooled to room temperature and was transferred to a new 1 L round bottom flask. PGME (52 g) was added and solvent exchange procedure from acetone to PGME is performed. The solid content is adjusted to 25%.

Nanoparticles based on silica having a RI of 1.25 and a film thickness of at least 1.5 μm):

Example 26:

### Step 1: Hydrolysis

In a 10 L reactor, EtOH (3650 g) and HCl (1M, 763.8 g) were mixed. A mixture of TEOS (675 g) and MTMS (237.6 g) was added dropwise over 40 minutes. The reaction mixture was then stirred overnight at room temperature.

### Step 2: Washing 1 and Solvent Exchange 1

A mixture of DI-H₂O (4982.9 g) and MTBE (5566.05 g) was then added to the reaction mixture, which was further stirred for few minutes at room temperature. Additional DI-H₂O (2386 g) was added dropwise, and the phases were separated. The organic phase was additionally washed with DI-H₂O (3×2386 g). After separation of the phases, EtOH (3009 g) was added to the organic phase. Solvent exchange from EtOH-MTBE-MeOH to EtOH was performed under reduced pressure. The solid content of the reaction mixture was adjusted to 4% by addition of EtOH (2478 g). The reaction mixture was stirred at room temperature overnight.

### Step 3: Condensation

TEA (2% of total solid content, 3.76 g) in EtOH (3.76 g) was added slowly to the reaction mixture, which was further stirred at T=95° C. for 48 min.

### Step 4: Washing 2 and Solvent Exchange 2

After cooling to room temperature, a mixture of DI-H₂O (2025 g) and MTBE (4050 g) was then added to the reaction mixture, which was stirred for few minutes at room temperature. Additional DI-H₂O (1864 g) was added dropwise, and the phases were separated. The organic phase was additionally washed with DI-H₂O (2×1864 g and 1×932 g). After separation of the phases, PGME (3391 g) was added to the organic phase. Solvent exchange from EtOH-MTBE-MeOH to PGME was performed under reduced pressure. The solid content of the reaction mixture was adjusted to 4% by addition of PGME.

### Step 5: End-Capping and Solvent Exchange 3

ClSiMe₃ (1% of solid content, 1.725 g) was added slowly to the reaction mixture, which was stirred at T=105° C. for 1.5 h. After cooling to room temperature, some solvents from the reaction mixture (TEA and PGME) were removed under low pressure to give a PGME-based material as 5.56% solid content.

### Step 6: Baking 5 Min at T=200° C.->RI=1.244/Thickness=1927 nm (3 Layers)

The formed polymers were subjected to spin-coating on silicon wafer at 400-2000 rpm. Then, the coated silicon wafer was baked at T=200° C. for 5 min. The refractive index and thickness were measured using filmetric apparatus and/or ellipsometer at 632 nm. Several coatings (up to 5 layers) were attempted in some instance in an attempt to reach the target of 1500 nm. In this Example (26), a cladding with a refractive index of 1.244, measured at 632 nm, and a thickness of 1,927 nm was provided.

### INDUSTRIAL APPLICABILITY

Aspects of the present invention can be used as claddings (coating layers) in display devices, touch screen devices, photovoltaic devices (cells, panels, and modules), luminaires, construction glass units and apparatuses.

### REFERENCE LIST

Legrand et al. J. Appl. Polym. Sci. 2021, vol. 138, issue 21, p. 50467
Mori et al., Polymer 2011, 52, pp. 5452-5463
Fuji et al., Colloids and Surfaces A: Physiochem. Eng. Aspects, 2015, 482, pp. 81-86
Zou et al., Surface and Coatings Technology 2018, 341, pp. 57-63
JP 2016020049
JP 5549966
JP 2012121277
JP 2007016081
JP 2011145438
WO 2007013329
WO 2013114945

1. An optical substrate having a surface and a cladding on said surface, said cladding comprising a polysiloxane polymer, a thickness of at least 1.5 μm, and a refractive index of less than 1.45, measured at 632 nm.

2. The optical substrate according to claim 1, wherein the refractive index of the cladding is less than 1.4, measured at 632.

3. The optical substrate according to claim 1, wherein the refractive index of the cladding is from 1.2 to 1.4, measured at 632.

4. The optical substrate according to claim 1, wherein the thickness of the cladding is at least 2.0 μm.

5. The optical substrate according to any of the preceding claim 1, wherein the thickness of the cladding is from 1.5 to 2.5 μm.

6. The optical substrate according to claim 1, wherein the polysiloxane polymer is formed from polymerization of a plurality of monomers according to one or more of the following formulas: 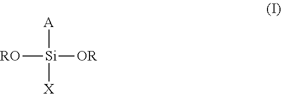
wherein R=alkyl,
A=alkyl, phenyl, vinyl, alkoxy, H atom, 5-(Bicycloheptenyl), glycidoxypropyl, or methacryloxypropyl, and
X=alkyl, phenyl, vinyl, alkoxy, H atom, 5-(Bicycloheptenyl), glycidoxypropyl, or methacryloxypropyl; 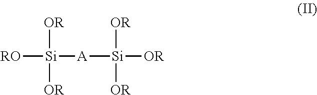
wherein R=alkyl, and
A=alkyl; 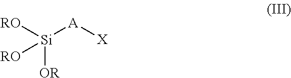
R=alkyl,
A=alkyl, and
X=N,N-bis(2,3-dihydroxypropyl)amino or (3-(allyloxy)-propan-2-ol)amino; 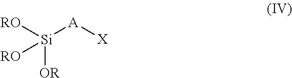
wherein R=alkyl,
A=alkyl, and
X=(CF₂)ₙCF₃, wherein n=3 to 20; 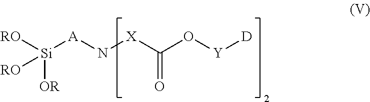
wherein R=alkyl,
A=alkyl,
X=alkyl,
Y=alkyl, and
D=(CF₂)ₙCF₃, wherein n=2 to 20;
or 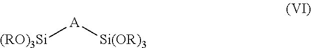
wherein R=alkyl;

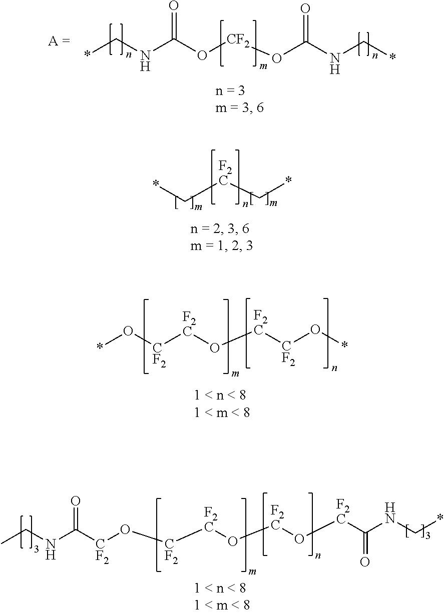

7. The optical substrate according to claim 1, wherein the cladding is formed from the polymerization of monomers having two or more of the formulas according to Formulas (I), (II), (III), (IV), (V), and (VI).

8. The optical substrate according to claim 1, wherein the polysiloxane polymer is formed from the polymerization of both non-fluoro-containing monomers and fluoro-containing monomers.

9. The optical substrate according to claim 1, wherein the polysiloxane polymer is formed from the polymerization of monomers selected from one or more of Formulas (I), (II), or (III) along with monomers selected from one or more of Formulas (IV), (V), and (VI).

10. The optical substrate according to claim 1, wherein the polysiloxane polymer is formed from the polymerization of monomers selected from the group consisting of tetraethoxysilane, methyltrimethoxysilane, methyltriethoxysilane, tetramethoxysilane, vinyltrimethoxysilane, 1H, 1H,2H,2H-perfluordecyltrimethoxysilane, bis(triethoxysilane)-terminated polyfluoroether, bis(triethoxysilane)-terminated poly(ethylene glycol), silanol-terminated polytrifluoropropylmethylsiloxane, and combinations thereof.

11. The optical substrate according to claim 1, wherein the polysiloxane polymer is formed from the polymerization of monomers selected from the group consisting of methyltrimethoxysilane (MTMS), tetraethoxysilane (TEOS), vinyltrimethoxysilane (VTMS), and combinations thereof.

12. The optical substrate according to claim 1, wherein the polysiloxane polymer is formed from the polymerization of at least monomers according to Formula VI, wherein the monomers of formula VI are selected from the group consisting of dodecafluorooctyl bis(triethoxysilyl)propyl)carbamate, hexafluoropentyl bis(triethoxysilyl)propyl)carbamate, 4,4,17,17-tetraethoxy-8,8,9,9,10,10, 11, 11, 12, 12, 13, 13-dodecafluoro-3,18-dioxa-4,17-disilaeioxane, 4,4,15,15-Tetraethoxy-7,7,8,8,9,9,10,10,11,11,12,12-dodecafluoro-3,16-dioxa-4,15-disilaeioxane, poly(tetrafluoroethylene), triethoxysilyl terminated, and combinations thereof.

13. The optical substrate according to claim 1, wherein the polymer comprises a weight average molecular weight of 1,000 g/mol to 190,000 g/mol.

14. The optical substrate according to claim 1, wherein the polysiloxane polymer comprises an amount of air entrained within spaces defined by a polymer backbone of the polymer, wherein the presence of the amount of air is effective to reduce a refractive index of the film.

15. The optical substrate according to claim 1, wherein the monomers each comprise 3, 4, or 6 reactive sites to form the spaces defined by the polymer backbone.

16. The optical substrate according to claim 1, wherein the substrate comprises a member selected from the group consisting of silica glass, aluminosilicate glass, silicon wafer, indium tin oxide (ITO) glass, polycarbonate (PC), polyethylene (PE), polyethylene (PE), polyethylene terephthalate (PET), poly(methyl methacrylate) (PMMA), and combinations thereof.

17. An optical substrate having a surface and a cladding on said surface, said cladding comprising a polysiloxane polymer in the form of a silsesquioxane, a thickness of at least 1.5 μm, and a refractive index of 1.45 or less, measured at 632 nm, wherein the polymer is formed from the polymerization of a plurality of methyltrimethoxysilane (MTMS) monomers along with at least one other monomer according to one or more of the following formulas: 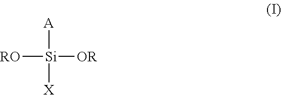
wherein R=alkyl,
A=alkyl, phenyl, vinyl, alkoxy, H atom, 5-(Bicycloheptenyl), glycidoxypropyl, or methacryloxypropyl, and
X=alkyl, phenyl, vinyl, alkoxy, H atom, 5-(Bicycloheptenyl), glycidoxypropyl, or methacryloxypropyl; 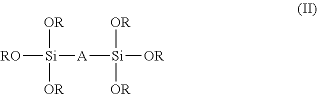
wherein R=alkyl, and
A=alkyl; 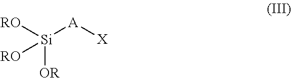
R=alkyl,
A=alkyl, and
X=N,N-bis(2,3-dihydroxypropyl)amino or (3-(allyloxy)-propan-2-ol)amino; 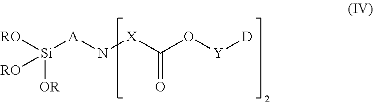
wherein R=alkyl,
A=alkyl,
X=alkyl,
Y=alkyl, and
D=(CF₂)ₙCF₃, wherein n=2 to 20;
or 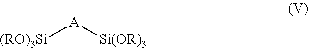
wherein R=alkyl; 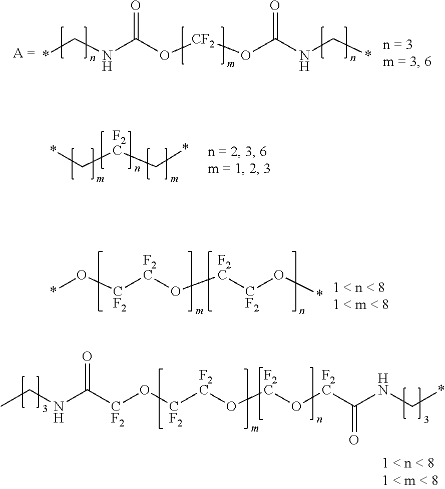
wherein the methyltrimethoxysilane monomers are in molar excess compared to the at least one other monomer according to one or more of formulas (I) to (V).

18. The optical substrate according to claim 17, wherein a molar ratio of the methyltrimethoxysilane monomers to the at least one other monomer according to one or more of formulas (I) to (V) is 5:1 to 7:1.

19. A method for forming an optical substrate comprising:
polymerizing a plurality of monomers to form a polysiloxane polymer; and
depositing the polysiloxane polymer on an optical substrate to form a cladding comprising the polysiloxane polymer on the substrate, the cladding having a thickness of at least 1.5 μm and a refractive index of less than 1.45, measured at 632 nm.

20. The method according to claim 19, wherein the plurality of monomers comprises monomers according to one or more of the following formulas: 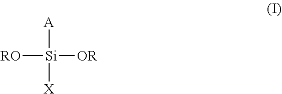
wherein R=alkyl,
A=alkyl, phenyl, vinyl, alkoxy, H atom, 5-(Bicycloheptenyl), glycidoxypropyl, or methacryloxypropyl, and
X=alkyl, phenyl, vinyl, alkoxy, H atom, 5-(Bicycloheptenyl), glycidoxypropyl, or methacryloxypropyl; 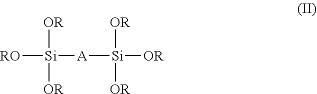
wherein R=alkyl, and
A=alkyl; 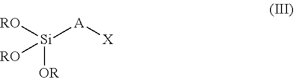
R=alkyl,
A=alkyl, and
X=N,N-bis(2,3-dihydroxypropyl)amino or (3-(allyloxy)-propan-2-ol)amino; 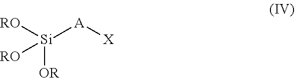
wherein R=alkyl,
A=alkyl, and
X=(CF₂)CF₃, wherein n=3 to 20; 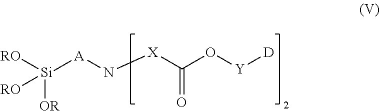
wherein R=alkyl,
A=alkyl,
X=alkyl,
Y=alkyl, and
D=(CF₂)ₙCF₃, wherein n=2 to 20;
or 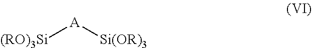
wherein R=alkyl;

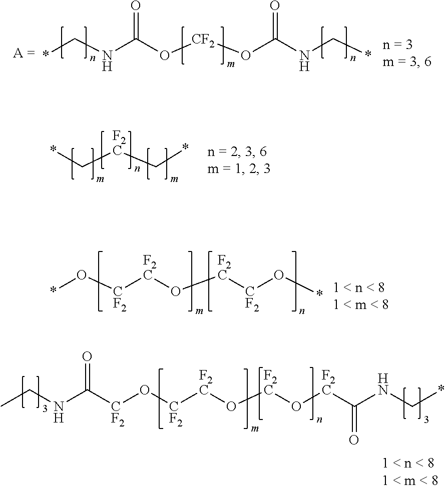

21. The method according to claim 12, wherein the monomers selected from one or more of Formulas (I), (II), or (III) along with monomers selected from one or more of Formulas (IV), (V), and (VI).

22. The method according to claim 19, wherein the polymerizing comprises:
mixing monomers according to one or more of Formulas (I) to (VI) with a first solvent and a first catalyst under conditions effective to hydrolyze the monomers and form a first reaction mixture; and
performing a first solvent extraction of the first reaction mixture with a first aqueous solvent to provide a first organic phase comprising the monomers, wherein the first aqueous solvent is different from the first solvent;
changing the first solvent to a second solvent to form a second reaction mixture;
subjecting the second reaction mixture to a polycondensation reaction for polymerizing and cross-linking of the monomers in the second reaction mixture; and
performing a second solvent extraction of the second reaction mixture with a second aqueous solvent to provide a second phase comprising the polymer formed from the monomers according to one or more of formulas (I) to (VI).

23. The method of claim 19, further comprising endcapping the polymer with an endcapping agent, wherein the endcapping agent is selected from the group consisting of fluoro(difluoromethylene)methyl silane, dimethoxy fluoro methyl silane, (2-chloroethyl)trimethoxysilane, ethyltrimethylsilane, ethyltriethylsilane, ethyltriethoxysilane, ethyltrimethoxysilane, chlorotrimethylsilane, chlorotriethylsilane, n-butyldimethylchlorosilane, t-butyldimethylchlorosilane, t-butyldiphethylchlorosilane, 4-(t-butyl)phenethyldimethylchlorosilane, chlorodimethylisobutylsilane, chlorodimethyl-n-propylsilane, (chloromethyl)dimethylphenylsilane, (chloromethyl)trimethylsilane, (3-chloropropyl)trimethylsilane, chlorotri-n-butylsilane, chlorotri-n-propylsilane, (3,3-dimethylbutyl)dimethylchlorosilane, ethyldimethylchlorosilane, isobutyldimethylchlorosilane, isopropyldimethylchlorosilane, t-hexyldimethylchlorosilane, p-tolyldemethylchlorosilane, triethylchlorosilane, and combinations thereof.

24. An optical substrate having a surface and a cladding on said surface, said cladding comprising a polysiloxane polymer in the form of a silsesquioxane, a thickness of at least 1.5 μm, and a refractive index of less than 1.45, measured at 632 nm, wherein the silsesquioxane is formed from the polymerization of at least a first monomer comprising a methyltrimethoxysilane (MTMS) monomer and one or more second monomers according to one or more of the following formulas: 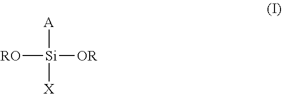
wherein R=alkyl,
A=alkyl, phenyl, vinyl, alkoxy, H atom, 5-(Bicycloheptenyl), glycidoxypropyl, or methacryloxypropyl, and
X=alkyl, phenyl, vinyl, alkoxy, H atom, 5-(Bicycloheptenyl), glycidoxypropyl, or methacryloxypropyl; 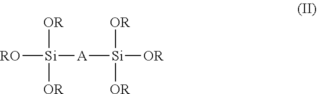
wherein R=alkyl, and
A=alkyl; 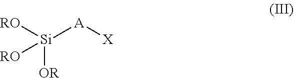
R=alkyl,
A=alkyl, and
X=N,N-bis(2,3-dihydroxypropyl)amino or (3-(allyloxy)-propan-2-ol)amino; 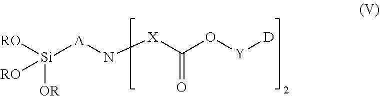
wherein R=alkyl,
A=alkyl,
X=alkyl,
Y=alkyl, and
D=(CF₂)ₙCF₃, wherein n=2 to 20;
or 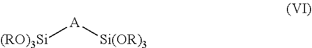
wherein R=alkyl; 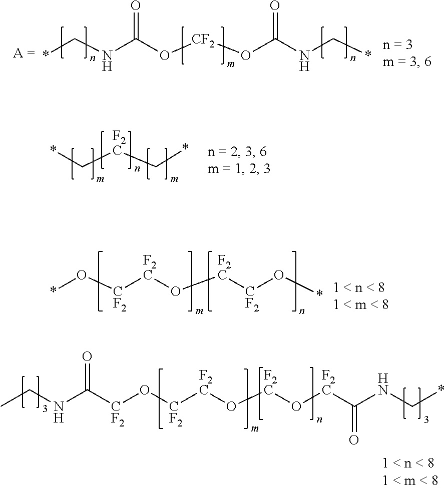
and wherein the methyltrimethoxysilane monomer is provided in molar excess compared to the one or more second monomers,
wherein the one or more second monomers are selected from one or more of Formulas (I), (II), or (III) along with monomers selected from one or more of Formulas (V) and (VI).
